(19) United States
(12) Patent Application Publication
(10) Pub. No.: US 2024/0385326 A1
(43) Pub. Date: Nov. 21, 2024

(54) FLASH LIDAR SENSOR USING ZOOM HISTOGRAMMING TDC

(71) Applicant: SOLIDVUE, INC., Seongnam-si (KR)

(72) Inventor: Jun Hee CHO, Seongnam-si (KR)

(73) Assignee: SOLIDVUE, INC., Seongnam-si (KR)

(21) Appl. No.: 18/689,242

(22) PCT Filed: Sep. 7, 2022
(86) PCT No.: PCT/KR2022/013415

§ 371 Date: Mar. 5, 2024

(30) Foreign Application Priority Data
Sep. 8, 2021 (KR) 10-2021-0119979
Sep. 1, 2022 (KR) 10-2022-0110930

(51) Int. Cl. G01S 17/894; G01S 7/481; G01S 7/4865

(52) U.S. Cl. CPC G01S 17/894; G01S 7/4816; G01S 7/4865

(57) ABSTRACT

The present invention relates to a flash LiDAR sensor using a zoom histogramming time-to-digital converter (TDC). One aspect of the present invention is a LIDAR sensor including a plurality of pixels, in which each of the plurality of pixels includes a TDC using a histogram method, the TDC performs a histogram operation by using M/2 up-down counters (UDCs), the TDC divides a section to be measured into M time bins, and each of the M time bins is allocated to correspond to either an up count or a down count of the M/2 UDCs.

### TECHNICAL FIELD

The present invention relates to a LIDAR sensor. Specifically, the present invention relates to a flash LiDAR sensor using a zoom histogramming time-to-digital converter (TDC).

### BACKGROUND ART

Recently, as metaverse applications running on mobile devices or unmanned vehicles have attracted attention, the demand for acquiring a depth image is increasing. The light detection and ranging sensor (LiDAR sensor) based on time of flight (ToF) technology is one of the strong candidates for real-time distance measurement. The ToF technique may be mainly classified into direct ToF (dToF) and indirect ToF (iToF) depending on whether extracted depth map information is a time difference between laser pulses or a modulated phase difference between irradiated light and reflected light. An iToF sensor is useful for providing high spatial resolution and low depth error, but is generally limited in maximum distance by a low optical gain and a period of a modulating waveform. In addition, the iToF sensor is vulnerable to background light and has disadvantages in outdoor environments. In contrast, a dToF sensor using a high-sensitivity single photon avalanche diode (SPAD) can extend its detectable range to hundreds of meters. In addition, the time-to-digital converter (TDC), which uses the time-correlated single photon counting (TCSPC) method with the coincidence detection circuit (CDC), effectively attenuates background light to make the dToF sensor suitable for outdoor use.

In view of the fact that light output density is limited considering eye-safety, a single point or 1-D line type emitter that increases the maximum distance by concentrating light of limited output into a small area may be desirable. In this case, a rotating mirror for a 1-D LiDAR module equipped with both an emitter and a detector is needed to scan surrounding objects using a small Field of View (FoV). However, the scanning structure to support a delicate optical system that should be highly durable even in harsh environments has the problem of being not only large in size but also difficult to implement inexpensively.

In mobile applications, a small-sized, cost-effective LiDAR sensor is suitable even if the detection range is less than tens of meters, and thus full-flash LiDAR sensors that do not use rotating equipment are currently being intensively developed. They are attempting to reduce pixel size and increase spatial resolution by adopting 3D stacking processes and sharing the time-to-digital converters (TDCs), but there are still many challenges to be solved.

One of the most important problems hindering pixel reduction is a large capacity memory that stores tens of GS/s of ToF data in proportion to an array size. Since the TCSPC method requires drawing a histogram of collected ToF values, it requires recording all data generated from a pixel array for every laser shot. Existing LiDAR sensors used a method of designating a counter for every time bin by integrating the histogram function into a TDC called histogram TDC (hTDC). This method has the problem that the counter occupies a large area because the number of counters increases in response to depth resolution.

Another problem with the LiDAR sensor is noise caused by background light. The LiDAR sensors should detect light reflected from a subject by separating the light from background light, but when the background light is strong, there is a problem that it is not easy to detect the reflected light by separating it from the background light.

### DISCLOSURE OF THE INVENTION

### Technical Problem

An object of the present invention is to provide a LIDAR sensor that can increase the accuracy of distance (depth) information by reducing the influence of background light.

An object of the present invention is to provide a LIDAR sensor that can reduce memory requirements.

An object of the present invention is to provide a LIDAR sensor that can effectively increase a frame rate.

An object of the present invention is to provide a LIDAR sensor that can process high-speed light detection signals even without using a counter having high bandwidth.

### Technical Solution

One aspect of the present invention to achieve the purpose described above is a LIDAR sensor including a plurality of pixels, in which each of the plurality of pixels includes a time-to-digital converter (TDC) using a histogram method, the time-to-digital converter (TDC) performs a histogram operation by using M/2 up-down counters (UDCs), the time-to-digital converter (TDC) divides a section to be measured into M time bins, and each of the M time bins is allocated to correspond to either an up count or a down count of the M/2 up-down counters (UDCs).

In the LiDAR sensor, the M time bins may include a time bin corresponding to the up count and a time bin corresponding to the down count with substantially the same length for each of the M/2 up-down counters (UDCs), and the up count and the down count due to noise pulses may be executed substantially the same number of times in each of the M/2 up-down counters (UDCs) when noise pulses due to background light are uniformly distributed in the M time bins, so that the influence of the background light may be canceled out.

In the LiDAR sensor, the time-to-digital converter (TDC) may include a first mode (coarse mode) in which a plurality of steps are performed, and each time the plurality of steps are performed, the section to be measured may be reduced to 1/M compared to a previous step.

In the LiDAR sensor, M time bins of an nth step among the plurality of steps may be generated by dividing the time bin, which had the highest pulse intensity in an (n-1)th step, into M time bins, and a length of the time bin of the nth step may be substantially reduced to 1/M compared to the time bin of the (n-1)th step.

In the LiDAR sensor, a code corresponding to the time bin having the highest pulse intensity for each step of the plurality of steps of the first mode may be decided as a partial code of a first mode time of flight (ToF_coarse).

In the LiDAR sensor, the first mode (coarse mode) may include first to third steps, M is 4 and four time bins may be generated for each step, codes 00(2), 01(2), 10(2), and 11(2) may be sequentially allocated to the four time bins, a code of the time bin having the strongest pulse intensity in the first step (step C1) may be decided as upper two bits of the first mode time of flight (ToF_coarse), a code of the time bin having the strongest pulse intensity in the second step (step C2) may be decided as middle two bits of the first mode time of flight (ToF_coarse), and a code of the time bin having the strongest pulse intensity in the third step (step C3) may be decided as lower two bits of the first mode flight time (ToF_coarse), so that the first mode ToF_coarse of 6-bit is decided through the first to third steps.

In the LiDAR sensor, the time-to-digital converter (TDC) may further include a second mode (fine mode), M time bins having a length smaller than a length of the time bin generated in the last step of the first mode (coarse mode) may be generated in the second mode (fine mode), and a predetermined phase may be allocated to each of the M time bins of the second mode (fine mode).

In the LiDAR sensor, M=4, there may be two up-down counters (UDCs), and count values of the two up-down counters (UDCs) may be used to decide a ToF (ToF_fine) value of the second mode.

In the LiDAR sensor, the up-down counter (UDC) may count a signal generated through a coincidence detection circuit (CDC) in the first mode and the up-down counter (UDC) may count a signal that has not passed through the coincidence detection circuit (CDC) in the second mode.

In the LiDAR sensor, the up-down counter (UDC) may be an asynchronous/synchronous mixed type counter.

In the LiDAR sensor, each of the up-down counters (UDC) may include a plurality of flip-flops, and at least some of the plurality of flip-flops may receive a signal different from a signal which the remaining flip-flops receive at a clock input terminal.

In the LiDAR sensor, a signal SiPM generated from a light detection signal may be applied to a clock input terminal of any one of the plurality of flip-flops, and a signal generated from an output signal of the flip-flop in which the SiPM signal is applied to the clock input terminal thereof may be applied to clock input terminals of other flip-flops among the plurality of flip-flops.

In the LiDAR sensor, the flip-flop in which the SiPM signal is applied to the clock input terminal thereof may be a flip-flop that processes a least significant bit (LSB).

### Advantageous Effects

According to the LiDAR sensor of the present invention, the accuracy of distance (depth) information can be increased by reducing the influence of background light.

According to the LiDAR sensor of the present invention, memory requirements can be reduced.

According to the LiDAR sensor of the present invention, the frame rate can be effectively increased.

According to the LiDAR sensor of the present invention, high-speed light detection signals can be processed even without using a counter having a high bandwidth.

### BRIEF DESCRIPTION OF THE DRAWINGS

FIG. 1 shows a conceptual operating principle of DIQS hTDC using two up-down counters (UDCs), as an embodiment of the present invention.

FIG. 2 illustratively shows the principle of suppressing noise caused by background light using the up-down counter.

FIG. 3 illustrates an in-pixel time-to-digital converter (TDC) according to an embodiment.

FIG. 4 exemplarily shows an operation of a coincidence detection circuit (CDC).

FIG. 5 shows an enlarged view of a counting operation portion by the up-down counter in FIG. 3.

FIG. 6 illustrates an up-down counter according to an embodiment of the present invention.

FIGS. 7 and 8 illustrate operation waveforms of the up-down counter illustrated in FIG. 6.

### MODE FOR CARRYING OUT THE INVENTION

Hereinafter, some embodiments of the present invention will be described in detail through illustrative drawings. In adding reference numerals to constituent elements in each drawing, it should be noted that the same constituent elements are given the same reference numerals as much as possible even if they are shown in different drawings. In addition, in describing the present invention, if it is determined that a detailed description of a related known configuration or function may obscure the gist of the present invention, the detailed description thereof will be omitted.

In addition, in describing the constituent elements of the present invention, terms such as first, second, A, B, (a), (b), etc. may be used. These terms are only used to distinguish the constituent element from other constituent elements, and the nature, order, or order of the constituent element is not limited by the term. When a constituent element is described as being “connected,” “combined,” or “coupled” to another constituent element, the constituent element may be directly connected or coupled to the other constituent element, but it should be understood that another constituent element may be “connected,” “combined,” or “coupled” between respective constituent element.

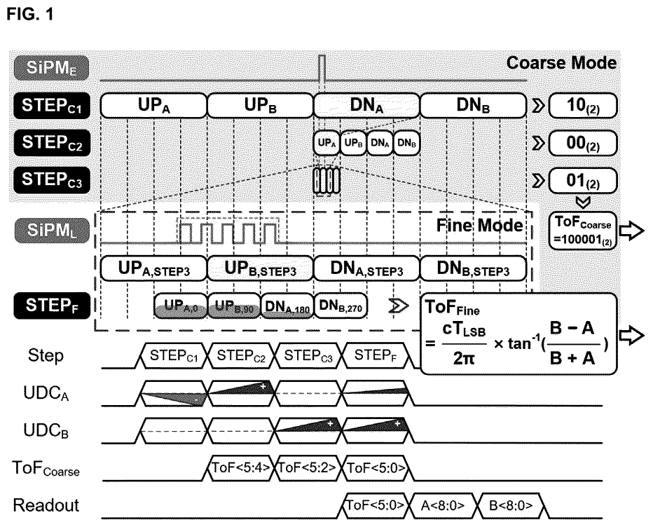

FIG. 1 shows a conceptual operating principle of a delta-intensity quaternary search (DIQS) histogramming time-to-digital converter (hTDC) using two up-down counters (UDCs). Here, the DIQS hTDC means a histogram TDC method according to an embodiment of the present invention.

In a first step STEP_C1 of a first mode (coarse mode), the DIQS hTDC may divide the entire period corresponding to the maximum detectable range substantially equally into a plurality of time bins UP_A, UP_B, DN_A, and DN_B and grasp the time bin where light reflected by a target object is located by accumulating pulse counts in each time bin when a pulse occurs. In FIG. 1, the case of dividing the time bins into four time bins UP_A, UP_B, DN_A, DN_B is illustrated, but the number of time bins is not limited to four. Hereinafter, the ‘time bin’ is also referred to simply as ‘bin’.

For example, if the beans are divided into 4 beans, they can be identified as follows. Among the four bins, a first pair consisting of UP_A and UP_B and a second pair consisting of DN_A and DN_B can be classified by whether a counting operation of the up-down counter (UDC) is an increase or decrease. That is, the first pair of UP_A bin and UP_B bin may correspond to an up count, and the second pair of DN_A bin and DN_B bin may correspond to a down count. The bins UP_A DN_A located in odd numbers and the bins UP_B and DN_B located in even numbers may belong to different up-down counters (UDCs). For example, the bins UP_A and DN_A located in odd numbers may correspond to a first up-down counter UDC_A, and the bins UP_B and DN_B located in even numbers may correspond to a second up-down counter UDC_B. In this way, four bins consisting of UP_A, UP_B, DN_A, and DN_B are generated, each of which can correspond to each of 2-bit digital ToF codes 00(2), 01(2), 10(2), and 11(2) in order (The number 2 in parentheses in 00(2), etc. means a binary number). Each of the last letters A and B of the names of bins UP_A, UP_B, DN_A, and DN_B represent the corresponding up-down counter (UDC).

When a photodiode (e.g., SPAD) detects incident light and generates a pulse, an up-down counter (UDC) value may increase or decrease depending on the time bin to which the pulse belongs. For example, when a pulse is generated in a section of UP_A bin, the first up-down counter UDC_A may be increased, when a pulse is generated in a section of UP_B bin the second up-down counter UDC_B may be increased, when a pulse is generated in a section of DN_A bin, the first up-down counter UDC_A may be decreased, and when a pulse is generated in a section of DN_B bin, the second up-down counter UDC_B may be decreased.

After repeating the pulse counting, a ToF code may be allocated depending on which value is greater than the other and what its sign is, by comparing absolute values of the two up-down counters (UDCs). A and B, which are the IDs of the up-down counter (UDC) having a large absolute value, can determine the least significant bit (LSB) of a 2-bit ToF_coarse code as 0 and 1, respectively (The final ToF_coarse can be 6 bits by generating 2 bits at each step and going through all three steps STEP_C1, C2, C3). The most significant bit (MSB) of the 2-bit ToF_coarse code is set to the sign of the up-down counter (UDC) value with a large absolute value, and a positive value and a negative may be mapped to 0 and 1, respectively. For example, if the value of UDC_A is −5 and the value of UDC_B is −3, since the absolute value of UDC_A is larger, LSB=0, and since the value of UDC_A is negative, MSB=1, and thus the ToF code can be set to 10(2).

Referring to the example in FIG. 1, since a pulse (SiPM_E; SiPM_E will be described in detail below) generated by light incident on the photodiode (SPAD) is located in the DN_A bin in STEP_C1, the UDC_A performs down counting and has a negative value, and the UDC_B has a value of 0 because there is no increase or decrease. Therefore, ToF_coarse<5:4> (In the first mode (coarse mode), a 2-bit ToF_coarse code is generated at each step and the ToF_coarse code has a 6-bit value through three steps STEP_C1, C2, C3. STEP_C1 is the first step and decides upper 2 bits of the 6-bit ToF_coarse code, and thus it is expressed as ToF_coarse<5:4>) can be set to 10(2). This means that the detected light belongs to the DN_A bin.

In the second step STEP_C2, the section of the bin (DN_A in the example of FIG. 1) to which the pulse is determined to belong (or which is determined to have the strongest pulse intensity if there are multiple pulses) in the first step STEP_C1 can be divided into four bins to be allocated. That is, the section of the DN_A bin in the first step STEP_C1 is divided again using four bins whose section length is ¼ that of the first step STEP_C1, and UP_A, UP_B, DN_A, and DN_B may be allocated thereto in that order.

In the second step STEP_C2, a ToF_coarse<3:2> value may be decided according to a procedure similar to the first step STEP_C1. Referring to the example in FIG. 1, in the second step STEP_C2, since the SiPM_E pulse belongs to the UP_A bin (assuming the position of the pulse is the same as in the first step), 00(2) can be allocated to ToF_coarse<3:2>. In FIG. 1, one SiPM_E pulse is shown as an example for convenience of explanation, but the position of the pulse is generally grasped by repeating it several times. In this case, as described above, the code can be decided through comparison of the magnitudes of the absolute values of the first up-down counter UDC_A and the second up-down counter UDC_B and their signs, which is substantially the same as the principle of deciding the code when there is one SiPM_E pulse.

In the third step STEP_C3, the section of the bin (UP_A bin in the example of FIG. 1) to which the pulse is determined to belong in the second step STEP_C2 may be divided again into four bins to be allocated. That is, the section of the UP_A bin in the second step STEP_C2 may be divided again using four bins with a section length of ¼ of that in the second step STEP_C2, and UP_A, UP_B, DN_A, and DN_B may be allocated thereto in that order.

In the third step STEP_C3, a ToF_coarse<1:0> value can be decided according to a procedure similar to the previous step. Referring to the example of FIG. 1, in the third step STEP_C3, since the SiPM_E pulse belongs to the UP_B bin, 01(2) may be allocated to ToF_coarse<1:0>.

If all steps 1, 2, and 3 STEP_C1, C2, C3 are performed, all of 6-bit values of ToF_coarse<5:0> may be decided. In the example of FIG. 1, ToF_coarse<5:0> has a value 100001(2).

When the first, second, and third steps STEP_C1, C2, C3 are performed, the section where the pulse is located can be narrowed from the entire period corresponding to the maximum detectable range to a time range reduced to (¼)³ thereof. For example, when the first, second, and third steps STEP_C1, C2, C3 of the first mode (coarse mode) are performed with a sensor with a maximum detection distance of 48 m, the time length of the bin in the third step STEP_C3 can be reduced to several ns to be similar to the width of the SiPM_E pulse, and may proceed to a second mode (fine mode). As such, according to this embodiment, it can be understood as a zoom-type histogram TDC in that each time a step is performed in the first mode (coarse mode), a section to be measured is reduced by a predetermined multiple compared to the previous step.

The second mode (fine mode) can be used to achieve higher resolution after extracting depth information based on a dToF method in the first mode (coarse mode). For example, after extracting the ToF_coarse<5:0> value through the first mode (coarse mode), more precise depth information can be extracted using a phase detection technique based on an iTOF method in the second mode (fine mode).

Using four beans in the second mode (fine mode) may be the same as in the first mode (coarse mode). In the second mode (fine mode), depth information can be extracted from a phase difference by obtaining the intensity of each bin in the four bins. The four bins used in the second mode (fine mode) may be configured in a similar manner as in the first mode (coarse mode). The four bins UP_A, UP_B, DN_A, and DN_B may represent phase delays of 0 degrees, 90 degrees, 180 degrees, and 270 degrees, respectively.

When illustratively described by way of example with reference to FIG. 1, SiPM_L, which is a pulse counted in a fourth step STEP_F of the second mode (fine mode), may be a signal that does not go through the coincidence detection circuit (CDC) compared to the pulse SiPM_E used in the first mode (coarse mode) (SiPM_L pulse will be described in detail below). As illustrated in FIG. 1, the SiPM_L pulse may occur over a plurality of bins. The first and second up-down counters UDC_A and UDC_B may perform up or down counting according to the corresponding bin each time the SiPM_L pulse signal occurs. In the example of FIG. 1, since the intensity (pulse generation frequency) of the UP_A bin is stronger than the intensity of the DN_A bin, the first up-down counter UDC_A will have a positive count value, and the second up-down counter UDC_B will also have a positive count value because there is no pulse occurrence in the DN_B bin while the intensity of the UP_B bin is strong. In addition, since the strength of the UP_B bin is stronger than the strength of the UP_A bin, the second up-down counter UDC_B will have a larger positive value than that of the first up-down counter UDC_A. When the counting for SiPM_L, which is a pulse occurring by light incident on the SPAD, ends in this way, the value of the first up-down counter UDC_A may be output as 9 bits of A<8:0>, and the value of the second up-down counter UDC_B may be output as 9 bits of B<8:0> (FIG. 1 illustrates the case of using a 9-bit up-down counter, but as the number of bits of the up-down counter, different values may be used depending on the situation). ToF_Fine may be calculated using the count value of the first up-down counter UDC_A and the count value of the second up-down counter UDC_B obtained through the second mode (fine mode) as shown in Equation 1 below.

$${ToF}_{Fine} = \frac{c \cdot {T}_{LSB}}{2 π} \cdot {tan}^{- 1} ( \frac{B - A}{B + A} ) \qquad [ Equation 1 ]$$

Here, c is the speed of light (km/s), and T_LSB is the length of one time bin in the last step STEP_C3 of the first mode (coarse mode).

High-resolution depth information can be obtained by utilizing four phase data obtained through four bins UP_A, UP_B, DN_A, and DN_B in the second mode (fine mode).

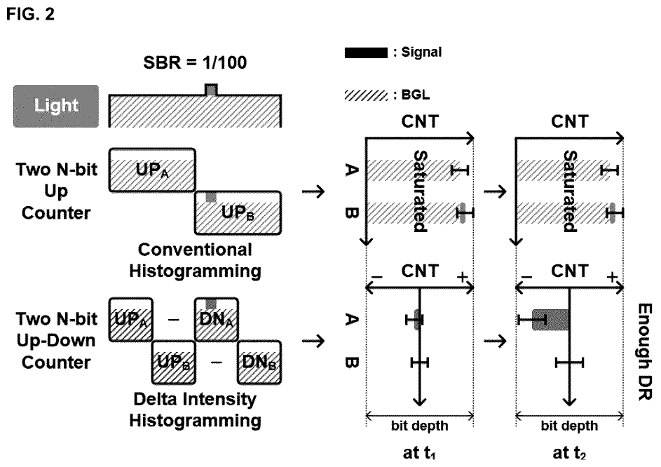

In this embodiment, noise caused by background light can be suppressed by using the up-down counters in the first mode (coarse mode) and the second mode (fine mode), and the principle thereof will be described with reference to FIG. 2.

FIG. 2 illustrates a case of background light intensity (BGL) where a signal to background ratio (SBR) is about 1/100. Here, the background light is assumed to be uniformly distributed throughout the entire section. In the example of using an existing up counter, the reflected light signal occurs in the UP_B bin, and the intensity of the background light (BGL) is high. Accordingly, there is a problem that it is not easy to accurately detect the bin where the reflected light signal is located because count values of A counter without reflected light signal and B counter with reflected light signal reach saturation in such a short period of time that it is difficult to distinguish between the count values of the two counters.

In this embodiment, the difference value is counted using the up-down counter, and thus the influence of background light (BGL) can be reduced compared to the existing method using the up counter. In the example of FIG. 2, it is assumed that the reflected light signal occurs in the DN_A bin. When the BGL is uniformly distributed, the strength of the background light (BGL) in the UP_A bin and the DN_A bin is almost the same, and thus the up count in the UP_A bin and the down count in the DN_A bin are canceled with each other, so that the UDC_A is not saturated by the background light (BGL). Therefore, by repeated execution several times, the reflected light signal can be accumulated to a sufficient size in the UDC_A. In the case of the UDC_B, since the intensity of BGL in UP_B bin and DN_B bin is almost the same, the up count in UP_B bin and down count in DN_B bin are canceled with each other, and thus the count value of UDC_B substantially maintains a value of 0, thereby making it possible to detect repeated signals in an unsaturated state.

As described with reference to FIGS. 1 and 2, the DIQS hTDC method of this embodiment can reduce the influence of background light and reduce memory requirements by using the histogram method through the up-down counter. In addition, the DIQS hTDC method of this embodiment can increase a frame rate and reduce memory requirements by reducing the number of sub-frames by using a zoom method that reduces a search cycle by ¼ in each step of the first mode (coarse mode). If the search cycle is reduced by ¼ at each step, the intensity of the background light decreases by ¼ while maintaining the signal intensity. Accordingly, the signal to background ratio (SBR) also increases by 4 times at each step, and thus the influence of the background light can be reduced at a rapid rate.

FIGS. 1 and 2 illustrates that there are two up-down counters (UDCs), four bins are generated at each step, and the first mode (coarse) is performed in three steps, but these specific numbers are only examples for convenience of explanation, and this embodiment is not limited to these numbers.

When the principle described with reference to FIGS. 1 and 2 is applied and expanded, the time-to-digital converter (TDC) performs the histogram operation by using M/2 up-down counters (UDCs), the time-to-digital converter (TDC) divides the section to be measured into M time bins, and each of the M time bins can be allocated to correspond to either the up count or the down count of the M/2 up-down counters (UDCs).

Here, the M time bins include the time bin corresponding to the up count and the time bin corresponding to the down count with substantially the same length for each of the M/2 up-down counters (UDCs), and the up count and the down count due to noise pulses may be executed substantially the same number of times in each of the M/2 up-down counters UDCs when noise pulses due to background light are uniformly distributed in the M time bins, so that the influence of the background light may be canceled out.

In addition, the time-to-digital converter (TDC) may include the first mode (coarse mode) in which a plurality of steps are performed, and each time the plurality of steps are performed, the section to be measured may be reduced to 1/M compared to a previous step. In the LiDAR sensor, M time bins of an nth step among the plurality of steps may be generated by dividing the time bin, which had the highest pulse intensity in an (n-1)th step, into M time bins, and a length of the time bin of the nth step may be substantially reduced to 1/M compared to the time bin of the (n-1)th step. A code corresponding to the time bin having the highest pulse intensity for each step of the plurality of steps of the first mode may be decided as a partial code of a first mode time of flight (ToF_coarse).

In addition, the time-to-digital converter (TDC) may further include the second mode (fine mode), and M time bins having a length smaller than the length of the time bin generated in the last step of the first mode (coarse mode) may be generated in the second mode (fine mode), and a predetermined phase may be allocated to each of the M time bins of the second mode (fine mode). In the second mode (fine mode), it is preferable that four time bins are generated for phase difference calculation.

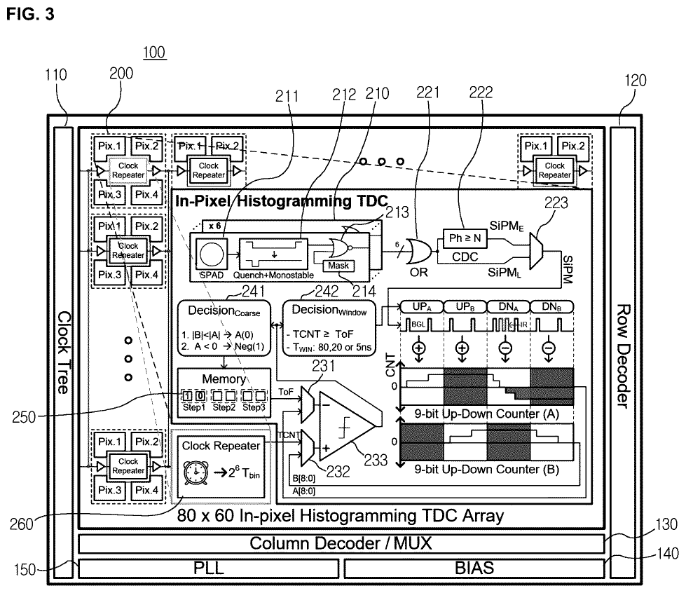

FIG. 3 illustrates a LIDAR sensor 100 according to one embodiment. The LIDAR sensor 100 may include a clock tree 110, a row decoder 120, a column decoder/multiplexer 130, a bias circuit 140, a phase locked loop (PLL) circuit 150, and a plurality of pixels 200.

The row decoder 120 can sequentially drive data of pixels of each row on a column data bus (not shown for read out of data.

The column decoder/multiplexer 130 can sequentially connect data driven on the column data bus to an output pad (not shown).

The bias circuit 140 can generate a bias voltage to be used by an in-pixel circuit inside the photo diode (SPAD).

The PLL circuit 150 can generate a clock to be used by the in-pixel circuit. For example, the PLL circuit 150 may receive a reference clock of 50 MHz from the outside, generate a master clock of 400 MHz, and provide it to the clock tree 110.

The clock tree 110 can generate multiple clocks to be used by the in-pixel circuit. For example, the clock tree 110 may divide the master clock of 400 MHz received from the PLL circuit 150 by ½ each 7 times to generate 8 clocks consisting of 400 MHz, 200 MHz, 100 MHz, . . . 3.125 MHz and provide them to a clock repeater 260.

Here, detailed description of the clock tree 110, row decoder 120, column decoder/multiplexer 130, bias circuit 140, and phase locked loop (PLL) circuit 150 may obscure the gist of the present invention, and thus detailed description thereof will be omitted.

The plurality of pixels 200 may be arranged in the LiDAR sensor 100, for example, in a matrix form. Illustratively, some of the plurality of pixels 200 may share the clock repeater 260. FIG. 3 illustrates that four pixels 200 share one clock repeater 260.

The clock repeater 260 can provide clocks of various frequencies provided from the clock tree 110 to the corresponding pixels 200. For example, the clock repeater 260 may transmit eight clocks provided from the clock tree 110 to the pixel 200. The TDC implemented in the pixel 200 may perform the DIQS hTDC process described with reference to FIG. 1 using a plurality of clocks provided from the clock repeater 260.

Each pixel 200 may include a plurality of photodiodes 211 and the TDC. In FIG. 3, the SPAD is illustrated as the photodiode. The SPAD is the most desirable device to be used in this embodiment because it can detect light with high sensitivity, but the photodiode of this embodiment is not limited to the SPAD and other types of photodiodes may be used. In addition, FIG. 3 illustrates a case where each pixel 200 includes six SPADs 211, but is not limited thereto.

In the embodiment of FIG. 3, the TDC may be of the in-pixel type implemented within each pixel 200. Below, the operation of the TDC implemented within each pixel will be described as an example. Here, the function of the TDC can be roughly understood as extracting time information from the pulse signal generated by optical detection of the SPAD and converting it into a digital value. The time information generated by TDC can be used to generate a depth map.

An output signal of the SPAD 211 may be output through a single stabilization circuit 212, an XOR gate 215, a mask circuit 214, etc. The single stabilization circuit 212, the XOR gate 215, and the mask circuit 214 may be provided to correspond to each SPAD 211.

The single stabilization circuit 212 can convert the pulse output from the SPAD 211 into a signal having a predetermined pulse width and output the signal. Since the single stabilization circuit 212 is provided for each SPAD 211, the output pulses of the plurality of SPADs 211 can be changed to have the same pulse width.

The XOR gate 215 and the mask circuit 214 can determine a time point at which the signal received from the single stabilization circuit 212 is output. For example, each of the outputs of the six SPADs 211 may be output to the OR gate 221 at a time point designated by the corresponding mask circuit 214. Signals output from the plurality of SPADs 211 may be converted into a serial signal in which the signals are continuously arranged through the OR gate 221. That is, an output of the OR gate 221 may be a signal in which pulses having substantially the same pulse width generated in response to the output pulses of the six SPADs 211 are continuously arranged.

The single stabilization circuit 212, the XOR gate 215, the mask circuit 214 and the OR gate 221 illustrated in FIG. 3 are only an example of a structure that converts output signals of the plurality of SPADs 211 into a serial signal and transmits the signal to a later stage, and this embodiment is not limited to this structure.

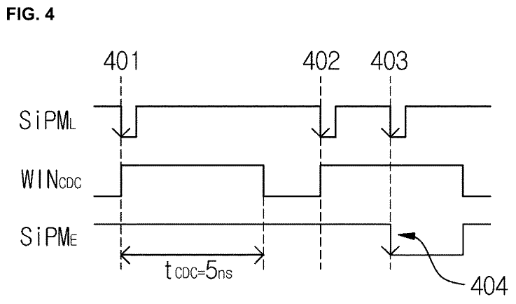

The output of the OR gate 221 itself may be a SiPM_L signal, and a signal generated by the SiPM_L signal passing through the coincidence detection circuit (CDC) 222 may be a SiPM_E signal. A method of generating the SiPM_E signal from the SiPM_L signal using the coincidence detection circuit (CDC) 222 will be described with reference to FIG. 4.

In the example of FIG. 4, when a falling edge occurs in the SiPM_L signal (401), a WIN_CDC signal may switch from a ‘low’ state to a ‘high’ state. The time t_CDC during which the WIN_CDC signal maintains the ‘high’ state may be a preset time (e.g., 5 ns). If no additional falling edge occurs in the SiPM_L signal within the time t_CDC during which the WIN_CDC signal maintains the ‘high’ state, the SiPM_E signal is not generated and the WIN_CDC signal may return to the ‘low’ state. When another falling edge occurs in the SiPM_L signal (402), the WIN_CDC signal switches from the ‘low’ state to the ‘high’ state again. If an additional falling edge occurs in the SiPM_L signal within the time during which the WIN_CDC signal maintains the ‘high’ state (403), the SiPM_E signal switches from the ‘high’ state to the ‘low’ state, and a SiPM_E signal 404 may be generated. In this embodiment, it is illustrated that the SiPM_E signal is generated when the SiPM_L signal is detected two or more times in a state where the WIN_CDC signal is ‘high’, but the number of SiPM_L signals for generating the SiPM_E signal may be set differently.

As such, the coincidence detection circuit (CDC) 222 may be understood as a circuit that determines whether or not pulses are generated (light is detected) simultaneously in a plurality of SPADs within the predetermined time period t_CDC. Considering that the SPAD is a highly sensitive light detection element, the coincidence detection circuit (CDC) 222 can be used to increase the reliability of the light detection signal.

The operation of the coincidence detection circuit (CDC) 222 illustrated in FIG. 4 is only an example for describing its function, and the operation of the coincidence detection circuit (CDC) 222 is not limited to this form. For example, as long as the principle described above is maintained, the ‘low’ and ‘high’ states in the SiPM_L, SiPM_E, and WIN_CDC signals may be set oppositely. In addition, the coincidence detection circuit (CDC) 222 may be selectively used depending on the situation.

Referring to FIG. 3 again, the SiPM_L signal, which is the output of the OR gate 221, and the SiPM_E signal generated through the coincidence detection circuit (CDC) 222) are input to the first multiplexer 223, and one selected from the SiPM_L signal and the SiPM_E signal may be used as an SiPM signal. In the exemplary description with reference to FIG. 1, the SiPM_E signal was used in the first mode (coarse mode) and the SiPM_L signal was used in the second mode (fine mode), but this embodiment is not limited thereto. Which of the SiPM_L signal and SiPM_E signal is to be used as the SiPM signal may be appropriately determined depending on the situation.

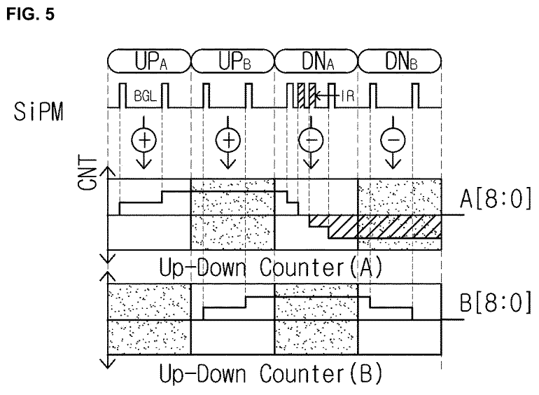

Next, the pulses of the SiPM signal can be counted by two up-down counters. The part describing the count operation by the up-down counter in FIG. 3 is enlarged and shown in FIG. 5.

Referring to FIG. 5, four time bins UP_A, UP_B, DN_A, and DN_B are generated, and two up-down counters UDC_A and UDC_B can perform the count operation corresponding to the time bin where the pulse is located.

In the example of FIG. 5, a background noise pulse (BGL) and a reflected light pulse (IR which is hatched) are mixed in the SiPM pulse. It is illustrated that two background noise pulses (BGL) are generated uniformly in each of four time bins, and two reflected light pulses (IR) are generated in the DN_A bin. The UDC_A performs the up count twice due to two background noise pulses (BGL) belonging to the UP_A bin and the down count four times due to two background noise pulses (BGL) and two reflected light pulses (IR) belonging to the DN_A bin, and as a result, it may have a value obtained by performing two down counts (hatched). The UDC_B performs the up count twice due to two background noise pulses (BGL) belonging to the UP_B bin and the down count twice due to two background noise pulses (BGL) belonging to the DN_B bin, and as a result, it may have a count value of substantially 0. The count values of the two up-down counters UDC_A and UDC_B can be output to a rear stage, respectively (A[8:0], B[8:0]).

The details of the counting operation by the two up-down counters UDC_A and UDC_B illustrated in FIG. 5 can be applied as described with reference to FIG. 1.

Referring to FIG. 3 again, a second multiplexer 231 receives ToF stored in the memory 250 and A[8:0], which is the output of the UDC_A, as input, and may selectively output one of the two values. The ToF stored in the memory 250 may be, for example, ToF_coarse obtained through the first mode (coarse mode) described with reference to FIG. 1.

A third multiplexer 232 receives TCNT received from the clock repeater 260 and B[8:0], which is the output of the UDC_B, as input, and may selectively output one of the two values.

A comparator 233 may compare and output the value input from the second multiplexer 231 and the value input from the third multiplexer 232. For example, the second multiplexer 231 may output the ToF, the third multiplexer 232 may output the TCNT, and the comparator 233 may output the result of comparing ToF and TCNT. Alternatively, the second multiplexer 231 may output A[8:0], the third multiplexer 232 may output B[8:0], and the comparator 233 can output the result of comparing A[8:0] and B[8:0].

The output of the comparator 233 may be input to a ToF_coarse decision unit 241 and a time bin window decision unit 242 of the first mode (coarse mode).

The ToF_coarse decision unit 241 may receive the result of the comparator 233 comparing A[8:0] and B[8:0]. As previously described with reference to FIG. 1, the ToF_coarse decision unit 241 may decide the ToF_coarse value according to the result of comparing the absolute values of the count values (A[8:0], B[8:0]) of the first and second up-down counters UDC_A and UDC_B and the sign of the value having a larger absolute value. To this end, the ToF_coarse decision unit 241 may receive the result of comparing A[8:0] and B[8:0] from the comparator 233, decide the ToF_coarse value according to the result, and transmit the result to the memory 250. The memory 250 may store the ToF_coarse value decided by the ToF_coarse decision unit 241 step by step, and store a 6-bit ToF_coarse value when all three steps are completed.

The bin window decision unit 242 may receive the result of comparing ToF and TCNT from the comparator 233, and use the result to generate a bin having an appropriate length at an appropriate time. The TCNT may be understood as a value that starts from 000000(2) and is up-counted one by one. The bin window decision unit 242 may generate a bin from the time point when the TCNT becomes equal to or greater than the ToF. For example, when the first step Step_C1 of the first mode (coarse mode) is completed and it is decided that ToF_coarse=10(2), the ToF at this time point becomes 100000(2). The up count of the TCNT starts from 000000(2) in order to find an execution time point of the second step Step_C2, and when the TCNT becomes equal to or greater than 100000(2), which is the value of ToF at this time point, the bin window decision unit 242 can start generating the bin. Depending on which step of the first mode it is, a preset value may be used for a length of bin T_win. For example, the length of bin T_win may be set to 80 ns (if the search range is 320 ns) in the first step Step_C1 of the first mode, the length of bin T_win may be set to 20 ns, which is reduced to ¼ thereof, in the second step Step_C2, and the length of bin T_win may be set to 5 ns, which is reduced to ¼ thereof, in the third step Step_C3. That is, the bin window decision unit 242 may be understood as deciding the timing for newly generating four bins having a ¼ length of that of the previous step within the bin where the pulse was detected in the previous step.

In the example of FIG. 3, the single stabilization circuit 212, the XOR gate 215, the mask circuit 214, the OR gate 221, the coincidence detection circuit (CDC) 222, the first multiplexer 223, two up-down counters UDC_A and UDC_B, the second multiplexer 231, the third multiplexer 232, the comparator 233, the ToF_coarse decision unit 241, the bin window decision unit 242, the memory 250, etc. included in each pixel 200 may be understood as only an example to describe the principle of the DIQS hTDC of this embodiment, and the DIQS hTDC of this embodiment is not limited to this structure. The DIQS hTDC of this embodiment may be implemented in various modified structures by applying the same principles as described with reference to the drawings in the same manner.

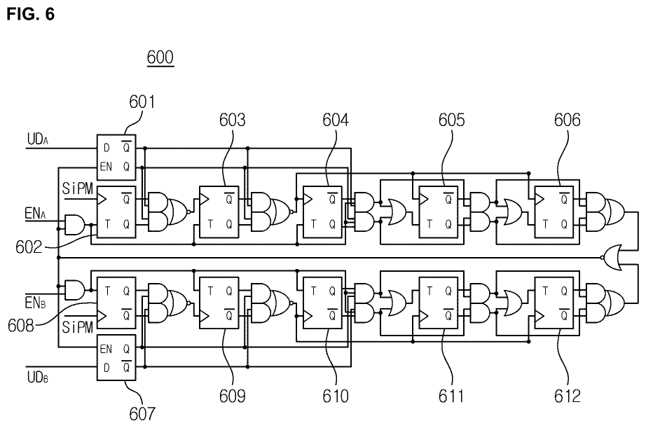

FIGS. 6 to 8 illustrate an up-down counter (UDC) and an operation waveform thereof according to an embodiment of the present invention. An up-down counter 600 illustrated in FIG. 6 is an asynchronous/synchronous mixed type counter and can process a SiPM signal having a very small pulse width (e.g., 500 ps).

Referring to FIG. 6, the up-down counter 600 may include a plurality of flip-flops and multiple AND, OR, XOR gates, etc. According to the embodiment, the plurality of flip-flops may include two D flip-flops 601 and 607 and ten T flip-flops 602 to 606 and 608 to 612.

The first to sixth flip-flops 601 to 606 may be included in the first up-down counter UDC_A and the seventh to twelfth flip-flops 607 to 612 may be included in the second up-down counter UDC_B.

Among the second to sixth flip-flops 602 to 606 included in the first up-down counter UDC_A, a signal different from a signal input to clock input terminals of the fourth to sixth flip-flops 604 to 606 may be applied to clock input terminals of the second and third flip-flops 602 and 603. As such, the first up-down counter UDC_A can be understood as an asynchronous/synchronous mixed type counter in that some of the flip-flops included in the first up-down counter UDC_A of this embodiment operate in synchronization with each other, but some of the flip-flops operate without being synchronized with each other. That is, at least some of the plurality of flip-flops included in the first up-down counter UDC_A may receive a signal, which is different from a signal input to the remaining flip-flops, at the clock input terminal thereof.

Specifically, the SiPM signal, which is a signal generated from the light detection signal, may be applied to the clock input terminal of the second flip-flop 602, and may operate in synchronization with an edge of the SiPM signal. A signal generated from the output signal of the second flip-flop 602 may be applied to the clock input terminal of the third flip-flop 603. In addition, a signal generated from the output signal of the third flip-flop 603 may be applied to the clock input terminals of the fourth to sixth flip-flops 604 to 606. The same signal is applied to the clock input terminals of the fourth to sixth flip-flops 604 to 606 such that the fourth to sixth flip-flops 604 to 606 may operate in synchronization with each other. That is, the signal SiPM generated from the light detection signal may be applied to the clock input terminal of any one flip-flop of the plurality of flip-flops and a signal generated from the output signal of the flip-flop in which the SiPM signal is applied to the clock input terminal thereof may be applied to the clock input terminals of other flip-flops. In this case, the flip-flop 602 in which the SiPM signal is applied to the clock input terminal thereof may be a flip-flop that processes the least significant bit (LSB).

By applying a high frequency SiPM to the clock input terminal of the second flip-flop 602 in the first up-down counter UDC_A, the second flip-flop 602 in charge of the LSB part can operate in response to the SiPM, which is a high-speed signal. Therefore, the first up-down counter UDC_A can process the high-speed SiPM signal without having a high bandwidth.

Typically, the pulse width of the SiPM signal is about several hundred ps (e.g., 500 ps). If it is assumed that the first up-down counter UDC_A uses a synchronous method, the first up-down counter UDC_A should have a bandwidth of 2 GHz or more to be able to operate normally. On the other hand, the first up-down counter UDC_A of this embodiment can count the SiPM signal, which is a high-speed signal, without having a high bandwidth by using a asynchronous/synchronous mixed method.

The second up-down counter UDC_B may also be implemented in the same way as the first up-down counter UDC_A.

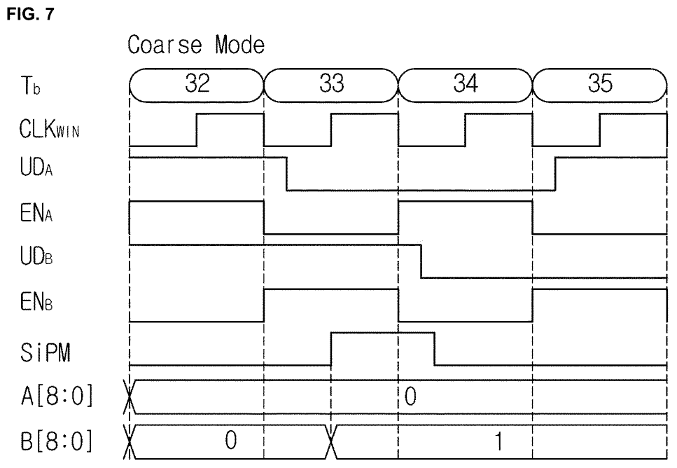

FIG. 7 illustrates the operation in the first mode (coarse mode) described with reference to FIG. 1.

In FIG. 7, UD_A may be a signal that decides whether the UDC_A counts up or down. For example, if the SiPM signal occurs when UD_A is in a ‘high’ state, the UDC_A may be up-counted, and if the SiPM signal occurs when UD_A is in a ‘low’ state, the UDC_A may be down-counted. Signal UD_B may also be used to decide whether the UDC_B counts up or down in the same way.

EN_A may be a signal that decides whether to count the UDC_A. For example, if the SiPM signal occurs when EN_A is in a ‘high’ state, the UDC_A may be up/down-counted, and when EN_A is in a ‘low’ state, the UDC_A may not be counted even if the SiPM signal occurs. EN_B may also be used to decide whether to count the UDC_B in the same way.

The UD_A, UD_B, EN_A, and EN_B may be understood as signals for controlling the up-down counters UDC_A and UDC_B. CLK_win may be a clock signal used to generate the signals UD_A, UD_B, EN_A, and EN_B for controlling the up-down counters UDC_A and UDC_B.

As described above, the SiPM is a signal generated based on a signal in which light is detected by the photodiode SPAD, and may be understood as a target signal to be counted by the up-down counters UDC_A and UDC_B. A[8:0] and B[8:0] may be the count values of the up-down counters UDC_A and UDC_B, respectively.

In FIG. 7, four sections in which T_b has values of 32, 33, 34, and 35, respectively, may be understood as four bins. For example, when assuming that ToF_coarse=10(2) is decided in the first step of the first mode and ToF_coarse=00(2) is decided in the second step, ToF_coarse up to the second step is=1000XX(2) (‘X’ means no value has not been determined. Since the third step has not been performed, the lower two bits have not yet been determined). In this case, in the third step, four bins will be generated starting from 100000(2) to 100011(2), and thus it may be understood that the four bins are allocated one by one to the decimal numbers 32, 33, 34, and 35.

In section 32, UD_A is in a ‘high’ state and EN_A is in a ‘high’ state, and thus if the edge of the SiPM pulse occurs in this section, the UDC_A can perform the up count. In section 33, UD_B is in a ‘high’ state and EN_B is in a ‘high’ state, and thus if the edge of the SiPM pulse occurs in this section, the UDC_B can perform the up count. In section 34, UD_A is in a ‘low’ state and EN_A is in a ‘high’ state, and thus if the edge of the SiPM pulse occurs in this section, the UDC_A can perform the down count. In section 35, UD_B is in a ‘low’ state and EN_B is in a ‘high’ state, and thus if the edge of the SiPM pulse occurs in this section, the UDC_B can perform the down count. In the example of FIG. 7, a rising edge of the SiPM occurs in section 33, and thus the UDC_B performs the up count and the B[8:0] value increases by 1 (In FIG. 7, it is illustrated that the rising edge of the SiPM signal is used, but a falling edge thereof may be used depending on the circuit implementation).

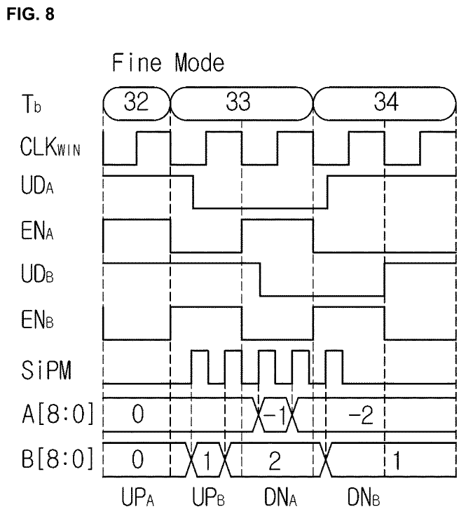

FIG. 8 illustrates the operation in the second mode (fine mode) described with reference to FIG. 1. As described with reference to FIGS. 3 and 4, in the second mode (fine mode), the SiPM_L signal that does not go through the CDC circuit may be used as the SiPM signal, and in this case, the SiPM signal may include more pulses.

FIG. 8 illustrates a state in which the frequency of the CLK_win is doubled compared to FIG. 7, and the frequencies of the control signals UD_A, EN_A, UD_B, and EN_B are also doubled. Therefore, the length of the bin in the second mode (fine mode) in FIG. 8 is half that of the bin in the first mode (coarse mode) in FIG. 7.

FIG. 8 illustrates the case where the SiPM signal includes five pulses, and among five pulses, the first and second rising edges occur in the UP_B section, the third and fourth rising edges occur in the DN_A section, and the last rising edge occurs in the DN_B section. As a result, the first up-down counter UDC_A has a value of −2 through two down counts, and the second up-down counter UDC_B has a value of +1 through two up counts and one down count.

In this way, the first and second up-down counters UDC_A and UDC_B illustrated in FIG. 6 B can perform up/down count operations for the high-speed SiPM signals in response to each of the four bins by the control signals UD_A, EN_A, UD_B, and EN_B, and the length of the bin can also be adjusted. In particular, the first and second up-down counters UDC_A and UDC_B have the advantage of processing the high-speed SiPM signal without having a high bandwidth by using the asynchronous/synchronous mixed method.

Terms such as “include”, “comprise”, or “have” described above, unless specifically stated to the contrary, mean that the corresponding constituent element can be inherent, and should therefore be interpreted as being able to include other constituent elements rather than excluding other constituent elements. All terms, including technical or scientific terms, unless otherwise defined, have the same meaning as generally understood by a person of ordinary skill in the technical field to which the present invention pertains. Commonly used terms, such as terms defined in a dictionary, should be interpreted as consistent with the meaning in the context of the related technology, and should not be interpreted in an idealized or overly formal sense unless explicitly defined in the present invention.

The description as above is merely an exemplary explanation of the technical idea of the present invention, and a person of ordinary skill in the technical field to which the present invention pertains will be able to make various modifications and variations made thereto without departing from the essential characteristics of the present invention. Accordingly, the embodiments disclosed in the present invention are not intended to limit the technical idea of the present invention, but are intended to explain it, and the scope of the technical idea of the present invention is not limited by these embodiments. The scope of protection of the present invention should be interpreted in accordance with the claims below, and all technical ideas within the equivalent scope thereof should be interpreted as being included in the scope of rights of the present invention.

1. A LIDAR sensor comprising:
a plurality of pixels, wherein
each of the plurality of pixels includes a time-to-digital converter (TDC) using a histogram method,
the time-to-digital converter (TDC) performs a histogram operation by using M/2 up-down counters (UDCs), and
the time-to-digital converter (TDC) divides a section to be measured into M time bins, and each of the M time bins is allocated to correspond to either an up count or a down count of the M/2 up-down counters (UDCs).

2. The LiDAR sensor of claim 1, wherein
the M time bins includes a time bin corresponding to the up count and a time bin corresponding to the down count with substantially the same length for each of the M/2 up-down counters (UDCs), and the up count and the down count due to noise pulses are executed substantially the same number of times in each of the M/2 up-down counters (UDCs) when noise pulses due to background light are uniformly distributed in the M time bins, so that the influence of the background light is canceled out.

3. The LiDAR sensor of claim 1, wherein
the time-to-digital converter (TDC) includes a first mode (coarse mode) in which a plurality of steps are performed, and
each time the plurality of steps are performed, the section to be measured is reduced to 1/M compared to a previous step.

4. The LiDAR sensor of claim 3, wherein
M time bins of an nth step among the plurality of steps are generated by dividing the time bin, which had the highest pulse intensity in an (n-1)th step, into M time bins, and a length of the time bin of the nth step is substantially reduced to 1/M compared to the time bin of the (n-1)th step.

5. The LiDAR sensor of claim 4, wherein
a code corresponding to the time bin having the highest pulse intensity for each step of the plurality of steps of the first mode is decided as a partial code of a first mode time of flight (ToF_coarse).

6. The LiDAR sensor of claim 5, wherein
the first mode (coarse mode) includes first to third steps, and
M is 4 and four time bins are generated for each step, codes 00(2), 01(2), 10(2), and 11(2) are sequentially allocated to the four time bins, and a code of the time bin having the strongest pulse intensity in the first step (step C1) is decided as upper two bits of the first mode time of flight (ToF_coarse), a code of the time bin having the strongest pulse intensity in the second step (step C2) is decided as middle two bits of the first mode time of flight (ToF_coarse), and a code of the time bin having the strongest pulse intensity in the third step (step C3) is decided as lower two bits of the first mode flight time (ToF_coarse), so that the first mode ToF_coarse of 6-bit is decided through the first to third steps.

7. The LiDAR sensor of claim 3, wherein
the time-to-digital converter (TDC) further includes a second mode (fine mode),
M time bins having a length smaller than a length of the time bin generated in the last step of the first mode (coarse mode) are generated in the second mode (fine mode), and
a predetermined phase is allocated to each of the M time bins of the second mode (fine mode).

8. The LiDAR sensor of claim 7, wherein
M=4, and there are two up-down counters (UDCs), and
count values of the two up-down counters (UDCs) are used to decide a ToF (ToF_fine) value of the second mode.

9. The LiDAR sensor of claim 7, wherein
the up-down counter (UDC) counts a signal generated through a coincidence detection circuit (CDC) in the first mode, and
the up-down counter (UDC) counts a signal that has not passed through the coincidence detection circuit (CDC) in the second mode.

10. The LiDAR sensor of claim 1, wherein
the up-down counter (UDC) is an asynchronous/synchronous mixed type counter.

11. The LiDAR sensor of claim 10, wherein
each of the up-down counters (UDC) includes a plurality of flip-flops, and
at least some of the plurality of flip-flops receive a signal different from a signal which the remaining flip-flops receive at a clock input terminal.

12. The LiDAR sensor of claim 11, wherein
a signal SiPM generated from a light detection signal is applied to a clock input terminal of any one of the plurality of flip-flops, and a signal generated from an output signal of the flip-flop in which the SiPM signal is applied to the clock input terminal thereof is applied to clock input terminals of other flip-flops among the plurality of flip-flops.

13. The LiDAR sensor of claim 12, wherein
the flip-flop in which the SiPM signal is applied to the clock input terminal thereof is a flip-flop that processes a least significant bit (LSB).
